(19) United States
(12) Patent Application Publication
(10) Pub. No.: US 2025/0112241 A1
(43) Pub. Date: Apr. 3, 2025

(54) SECONDARY BATTERY

(71) Applicant: MURATA MANUFACTURING CO., LTD., Kyoto (JP)

(72) Inventors: Takamasa ONO, Kyoto (JP); Tsuneo YAMAZAKI, Kyoto (JP)

(21) Appl. No.: 18/819,543

(22) Filed: Aug. 29, 2024

(30) Foreign Application Priority Data
Sep. 28, 2023 (JP) 2023-168606

(51) Int. Cl. H01M 4/62; H01M 50/431; H01M 50/443; H01M 50/489

(52) U.S. Cl. CPC H01M 4/622; H01M 50/431; H01M 50/443; H01M 50/489

(57) ABSTRACT

A secondary battery is provided and includes a positive electrode, a negative electrode, a separator, an adhesive layer provided on a principal face of the separator, and an electrolytic solution. The adhesive layer contains a water-soluble binder. With a region where the positive electrode, the negative electrode, and the separator are stacked and overlapped being defined as an electrode body region, the positive electrode and the negative electrode respectively have a positive electrode terminal and a negative electrode terminal that are portions protruding from the electrode body region in plan view in the first direction. The positive electrode terminal and the negative electrode terminal are located on the same side with respect to the geometric center of the electrode body region. When a region overlapping a shortest path in the electrode body region from a first boundary where the positive electrode terminal is connected to the electrode body region to a second boundary where the negative electrode terminal is connected to the electrode body region is defined as a first measurement region, and a region that is point-symmetric to the first measurement region about a geometric center of the electrode body region and has an area equal to that of the first measurement region is defined as a second measurement region, and where an area proportion occupied by the adhesive layer in the first measurement region is denoted by A and an area proportion occupied by the adhesive layer in the second measurement region is denoted by B, 1.1≤A/B≤1.5.

### CROSS REFERENCE TO RELATED APPLICATIONS

The present application claims priority to Japanese patent application no. 2023-168606, filed on Sep. 28, 2023, the entire contents of which are herein incorporated by reference.

### BACKGROUND

The present disclosure relates to a secondary battery.

A battery in which an electrode and a separator are joined using an acrylic binder is disclosed.

### SUMMARY

The present disclosure relates to a secondary battery.

However, since the acrylic binder is low in swellability with an electrolytic solution and does not gel, the ionic conductivity is low. For this reason, there is a possibility that the binder serves a resistance, a local charge-discharge reaction occurs in the battery device, and the cycle characteristics are deteriorated.

The present disclosure has been devised in view of the above problems, and relates to providing a secondary battery high in cycle characteristics according to an embodiment.

A secondary battery according to one aspect of the present disclosure, in an embodiment, includes: a positive electrode; a negative electrode; a separator stacked in a first direction between a principal face of the positive electrode and a principal face of the negative electrode; an adhesive layer provided on a principal face of the separator on at least one of a positive electrode side and a negative electrode side; and an electrolytic solution, in which the adhesive layer contains a water-soluble binder; a region where the positive electrode, the negative electrode, and the separator are stacked and overlapped is defined as an electrode body region; the positive electrode includes a positive electrode terminal that is a portion protruding from the electrode body region in plan view in the first direction; the negative electrode includes a negative electrode terminal that is a portion protruding from the electrode body region in plan view in the first direction; the positive electrode terminal and the negative electrode terminal are located on the same side with respect to a geometric center of the electrode body region in a direction orthogonal to the first direction; and when, in plan view in the first direction, a region overlapping a shortest path in the electrode body region from a first boundary where the positive electrode terminal is connected to the electrode body region to a second boundary where the negative electrode terminal is connected to the electrode body region is defined as a first measurement region, and a region that is point-symmetric to the first measurement region about a geometric center of the electrode body region and has an area equal to that of the first measurement region is defined as a second measurement region, and where an area proportion occupied by the adhesive layer in the first measurement region is denoted by A and an area proportion occupied by the adhesive layer in the second measurement region is denoted by B, a ratio of A to B is 1.1 or more and 1.5 or less.

According to the present disclosure, in an embodiment, a secondary battery having high cycle characteristics can be provided.

### BRIEF DESCRIPTION OF THE FIGURES

FIG. 1 is a development view illustrating one example of the secondary battery according to an embodiment;

FIG. 2 is an enlarged sectional view illustrating a part of a cross section of the battery device according to FIG. 1;

FIG. 3 is a schematic plan view of the battery device according to FIG. 1;

FIG. 4A is a schematic plan view illustrating one example of the separator and the adhesive layer according to FIG. 1;

FIG. 4B is a schematic plan view illustrating a different example of the separator and the adhesive layer according to FIG. 1;

FIG. 5A is a plan view illustrating the shape of a dot of the adhesive layer according to FIG. 4A;

FIG. 5B is a plan view illustrating the shape of a dot of the adhesive layer according to FIG. 4B;

FIG. 6 is a development view illustrating a different example of the secondary battery according to an embodiment;

FIG. 7 is a schematic view of a section taken along line VII-VII of FIG. 6; and

FIG. 8 is a schematic plan view of the battery device according to FIG. 6.

### DETAILED DESCRIPTION

Hereinafter, embodiments of the present disclosure will be described in further detail. Note that the present disclosure is not limited by the embodiments.

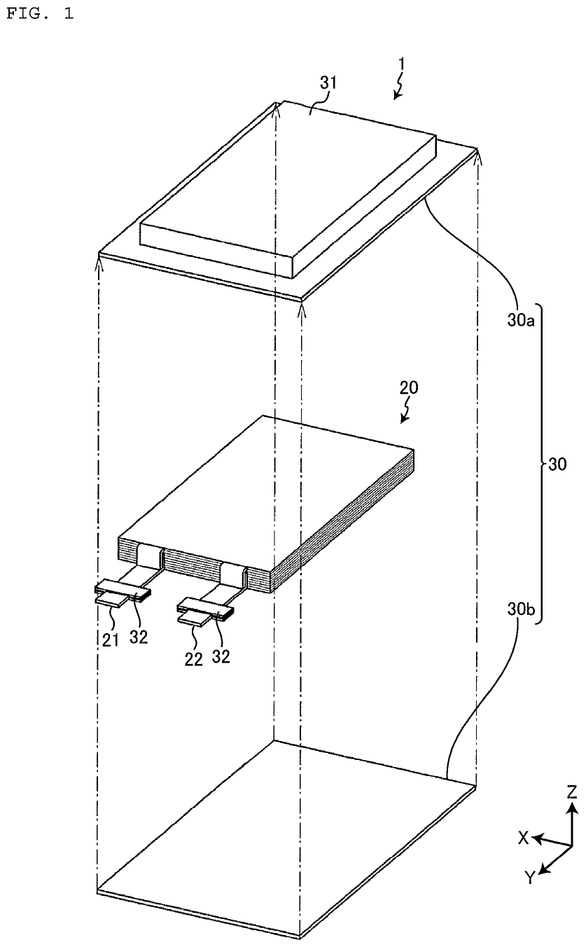

FIG. 1 is a development view illustrating one example of the secondary battery according to an embodiment. The secondary battery 1 illustrated in FIG. 1 is a laminate type lithium ion secondary battery. As illustrated in FIG. 1, the secondary battery 1 includes a battery device 20, an outer package member 30, and a close contact member 32. Details of the battery device 20 will be described later.

The outer package member 30 is a case in which the battery device 20 is housed. The outer package member 30 includes two exterior sheets 30a and 30b. The exterior sheets 30a and 30b each include an insulating layer, a metal layer, and an outermost layer. In the example of FIG. 1, a recess 31 is provided in the exterior sheet 30a. As a result, the battery device 20 is housed in the recess 31, and the peripheral edges of the exterior sheets 30a and 30b are bonded, whereby the battery device 20 is housed in the outer package member 30.

The exterior sheets 30a and 30b have a structure in which an insulating layer, a metal layer, and an outermost layer are stacked in this order from the inside, namely, from the side where the battery device 20 is provided, and stuck by lamination processing or the like. The insulating layer of each of the exterior sheets 30a and 30b is made of, for example, a resin such as polyethylene, polypropylene, modified polyethylene, modified polypropylene, or a polyolefin resin containing ethylene or propylene as a monomer. As a result, the exterior sheets 30a and 30b can lower the moisture permeability of the secondary battery 1A, and can improve the airtightness. The metal layer of each of the exterior sheets 30a and 30b is a plate material or a foil material of metal such as aluminum, stainless steel, nickel, or iron. The outermost layer may be made of an arbitrary material, but is preferably made of a material having high strength against breakage, piercing, or the like, such as a resin similar to that of the insulating layer, or nylon.

The close contact member 32 is a member for making the outer package member 30 hermetic. The close contact member 32 is provided between the outer package member 30 and the positive electrode lead 21 and between the outer package member 30 and the negative electrode lead 22. The material of the close contact member 32 preferably has close contact property to the positive electrode lead 21 and the negative electrode lead 22. For example, when the positive electrode lead 21 and the negative electrode lead 22 are each made of a metal material, a polyolefin resin such as polyethylene, polypropylene, modified polyethylene, or modified polypropylene is used as the close contact member 32. As a result, the close contact member 32 can keep the gap between the outer package member 30 and the positive electrode lead 21 and the gap between the outer package member 30 and the negative electrode lead 22 hermetic, so that the interior of the outer package member 30 can be made hermetic.

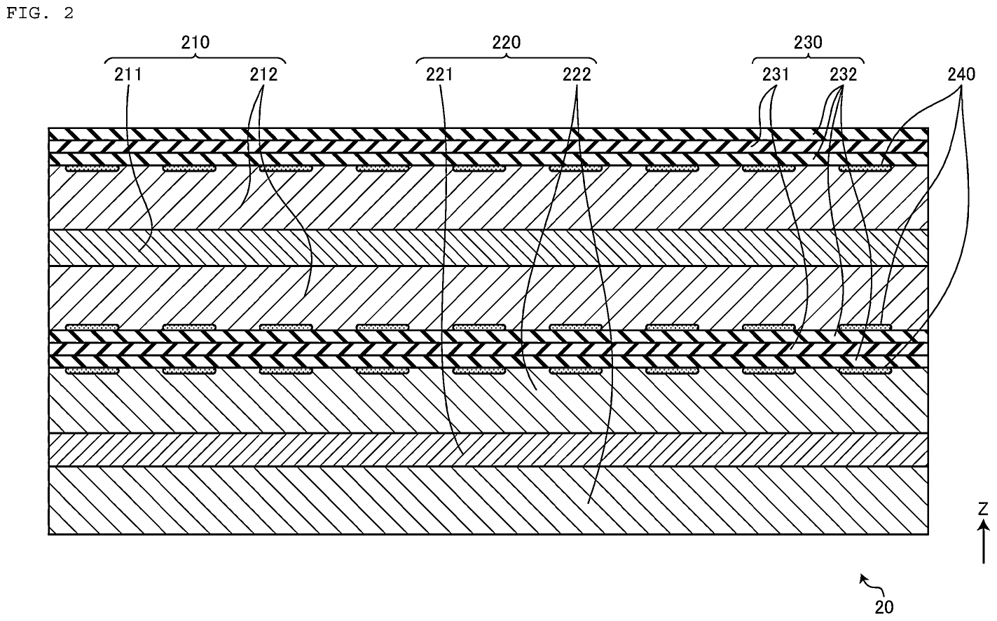

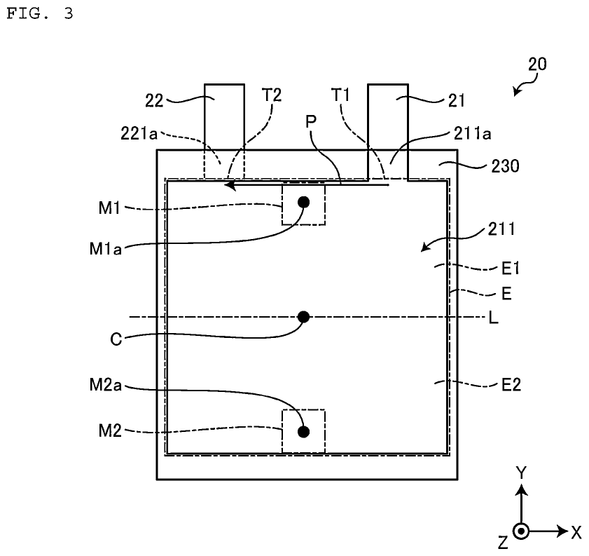

FIG. 2 is an enlarged sectional view illustrating a part of a cross section of the battery device according to FIG. 1. More specifically, FIG. 2 is a sectional view illustrating a part of one layer of the positive electrode 210 and one layer of the negative electrode 220 in the battery device 20. FIG. 3 is a schematic plan view of the battery device according to FIG. 1. More specifically, FIG. 3 is a plan view illustrating the battery device 20 in which the positive electrode 210, the separator 230, and the negative electrode 220 are stacked in this order. As illustrated in FIG. 2, the battery device 20 includes the positive electrode 210, the negative electrode 220, the separator 230, and the adhesive layer 240. In the secondary battery 1, the battery device 20 has a structure in which the positive electrode 210 and the negative electrode 220 are stacked in a thickness direction with the separator 230 interposed therebetween. The positive electrode 210 and the negative electrode 220 included in the battery device 20 are layered members for a charge-discharge reaction of the secondary battery according to an embodiment.

In the following description, a stacking direction of the positive electrode 210, the negative electrode 220, and the separator 230 is referred to as Z direction, a direction orthogonal to the Z direction is referred to as Y direction, and a direction orthogonal to the Y direction and the Z direction is referred to as X direction. Here, the Z direction is one example of the “first direction”. The Y direction is one example of a “direction orthogonal to the first direction”. A region where the positive electrode 210, the negative electrode 220, and the separator 230 overlap in plan view in the Z direction will be described as an electrode body region E. That is, the electrode body region E can be said to be a region where a charge-discharge reaction occurs in the secondary battery 1. The geometric center of the electrode body region E is described as the geometric center C of the electrode body region E. In the example of FIG. 3, the electrode body region E is a rectangular region.

The positive electrode 210 includes a positive electrode lead 21, a positive electrode current collector 211, and a positive electrode active material layer 212. In the positive electrode 210, the positive electrode current collector 211 is laminated between the positive electrode active material layers 212.

The positive electrode lead 21 is a terminal extended from the positive electrode current collector 211 described later to the outside of the outer package member 30. That is, the positive electrode lead 21 is a terminal serving as a positive electrode of the secondary battery 1A.

The positive electrode current collector 211 is a conductive layer and, for example, an aluminum foil, a stainless steel foil, or the like can be used. In the example of FIG. 1, the shape of the positive electrode current collector 211 is a rectangular sheet having a tab 211a protruding on the Y direction side in plan view in the Z direction, but is not limited thereto, and may be another shape such as a circular shape. The tab 211a is connected to the positive electrode lead 21.

The positive electrode 210 has a positive electrode terminal. The positive electrode terminal refers to a portion of the positive electrode 210 protruding from the electrode body region E. In the example of FIG. 3, the positive electrode lead 21 and the tab 211a correspond to a positive electrode terminal. In the following description, a boundary where the positive electrode terminal and the electrode body region E are connected to each other will be described as a first boundary T1. In the example of FIG. 3, the first boundary T1 refers to an end part of the tab 211a opposite from the positive electrode lead 21.

The positive electrode active material layer 212 is a layer containing a positive electrode active material. The positive electrode active material layer 212 contains a positive electrode active material, a binder, and a conductive aid. The positive electrode active material layer 212 is not limited to the materials described above, and may further contain, for example, a dispersant.

The positive electrode active material is preferably a lithium-containing compound such as a lithium-containing composite oxide or a lithium-containing phosphate compound. The lithium-containing composite oxide is an oxide containing lithium and one or more elements other than lithium as constituent elements. The lithium-containing composite oxide has, for example, a layered rock-salt type or spinel type crystal structure. The lithium-containing phosphate compound is a phosphate compound containing lithium and one or more elements other than lithium as constituent elements. The lithium-containing phosphate compound has, for example, an olivine type crystal structure. Examples of the lithium-containing composite oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Examples of the lithium-containing phosphate compound include LiFePO₄, LiMnPO₄, LiFe_{0.5}Mn_{0.5}PO₄, and LiFe_{0.3}Mn_{0.7}PO₄.

The positive electrode binder contained in the positive electrode active material layer 212 may be an arbitrary material, and contains, for example, one or more of synthetic rubber and a polymer compound. Examples of the synthetic rubber include styrene-butadiene-based rubber, fluorine-based rubber, and ethylene propylene diene. Examples of the polymer compound includes polyvinylidene fluoride (PVdF) and polyimide.

The conductive aid contained in the positive electrode active material layer 212 may be an arbitrary material, and contains, for example, carbon. Examples of the carbon include graphite, carbon black, acetylene black, and ketjen black. The conductive aid contained in the positive electrode active material layer 212 is not limited to those as long as it is a material having conductivity, and may be a metal material, a conductive polymer, or the like.

The negative electrode 220 includes a negative electrode lead 22, a negative electrode current collector 221, and a negative electrode active material layer 222. In the negative electrode 220, the negative electrode current collector 221 is laminated between the negative electrode active material layers 222.

The negative electrode lead 22 is a terminal extended from the negative electrode current collector 221 described later to the outside of the outer package member 30. That is, the negative electrode lead 22 is a terminal serving as a negative electrode of the secondary battery 1A.

The negative electrode current collector 221 is a conductor, and for example, a copper foil or the like can be used. In the example of FIG. 1, the shape of the negative electrode current collector 221 is a rectangular sheet having a tab 221a protruding on the Y direction side in plan view in the Z direction, but is not limited thereto, and may be another shape such as a circular shape. The tab 221a is connected to the negative electrode lead 22. The tab 221a will be described in detail later.

The negative electrode 220 has a negative electrode terminal. The negative electrode terminal refers to a portion of the negative electrode 220 protruding from the electrode body region E. In the example of FIG. 3, the negative electrode lead 22 and the tab 221a correspond to a negative electrode terminal. In the following description, a boundary where the negative electrode terminal and the electrode body region E are connected to each other will be described as a second boundary T2. In the example of FIG. 3, the second boundary T2 refers to an end part of the tab 221a opposite from the negative electrode lead 22.

The negative electrode active material layer 222 is a layer containing a negative electrode active material. The negative electrode active material layer 222 is not limited to be made of only the negative electrode active material, and may contain, for example, a conductive aid and a binder.

The negative electrode active material refers to a reducing agent capable of absorbing and desorbing charge carriers of the secondary battery 1 via a charge-discharge reaction, such as an alloy or compound of carbon, silicon, tin (Sn), a metal, or a metalloid.

Examples of the negative electrode active material containing silicon as a constituent element include a simple substance of silicon, an alloy of silicon, and a compound of silicon. Examples of the alloy of silicon that can be used as the negative electrode active material include one containing at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as a second constituent element other than silicon. Examples of the compound of silicon that can be used as the negative electrode active material include compounds of silicon containing oxygen (O) or carbon (C), such as silicon oxide (SiOₓ) and silicon carbide (Sic), and may contain the above-described second constituent element in addition to silicon. The negative electrode active material may be doped with Li. When the negative electrode active material is SiOₓ, the SiOₓ is preferably pre-doped with Li by doping it with Li in the step of negative electrode production. This makes it possible to reduce the irreversible capacity of SiOₓ as the negative electrode active material. The negative electrode active material may be a composite of Si and another substance such as carbon, or a composite of a Si alloy and another substance such as carbon. In this case, the irreversible capacity can be reduced. In addition, it is preferable that the particle surface of the negative electrode active material is partly or fully coated with carbon. Thereby, the electron conductivity of the particle surface of the negative electrode active material can be improved.

Examples of the negative electrode active material containing carbon as a constituent element include mesocarbon microbeads (MCMB), artificial graphite, natural graphite, non-graphitizable carbon, and graphitizable carbon. More specifically, the material that can be used as the negative electrode active material include pyrolytic carbons, cokes, glassy carbon fibers, organic polymer compound fired bodies, activated carbon, and carbon blacks. Examples of the cokes include pitch coke, needle coke, and petroleum coke. The organic polymer compound fired body is a substance obtained by firing a polymer compound such as phenol resin or furan resin at an appropriate temperature to carbonize.

Examples of the negative electrode active material containing tin as a constituent element include those containing at least one selected from the group consisting of nickel, copper, iron, cobalt, manganese, zinc, indium, silver, titanium, germanium, bismuth, antimony, and chromium as the second constituent element other than tin. Examples of the compound of tin that can be used as the negative electrode active material include those containing oxygen or carbon, and the compound of tin may contain the above-mentioned second constituent elements in addition to tin.

The negative electrode active material is not limited to those recited above, and may contain other negative electrode active materials, for example, a material capable of occluding and releasing lithium, such as an alloy or compound of a metal or metalloid, or an alloy or compound of tin (Sn). Examples of the metal and the metalloid that can be used as the negative electrode active material specifically include tin (Sn), lead (Pb), aluminum (Al), indium (In), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Among them, germanium, tin, and lead are preferable. Tin is more preferable because tin have a great ability to occlude and release lithium and a high energy density can be attained.

The separator 230 is a membrane that insulates the positive electrode 210 from the negative electrode 220. The separator 230 is provided between the positive electrode 210 and the negative electrode 220 so that the positive electrode 210 and the negative electrode 220 are not in direct contact with each other. In the example of FIG. 1, the shape of the separator 230 is a rectangular sheet in plan view in the thickness direction, but is not limited thereto, and may be another shape such as a circular shape. The separator 230 includes a substrate 231 and a heat-resistant layer 232.

Preferably, the material of the substrate 231 is electrically stable, is chemically stable against the positive electrode active material, the negative electrode active material, and the electrolytic solution, and has an insulating property. As the substrate 231, for example, a layer made of a polymer nonwoven fabric, a porous film, or a fiber of glass or ceramics can be used. The material of the substrate 231 more preferably includes a porous polyolefin film. Thereby, the safety of the battery can be improved due to the short circuit preventing effect and the shutdown effect.

The heat-resistant layer 232 is a layer that covers each of the principal faces on both sides of the substrate 231. The heat-resistant layer 232 contains a binder and particles made of an inorganic substance. When the heat-resistant layer 232 contains particles made of an inorganic substance, the heat resistance of the heat-resistant layer 232 can be improved, so that the heat resistance of the secondary battery 1 can be improved. In addition, owing to the fact that the heat-resistant layer 232 contains the binder, the adhesiveness of the adhesive layer 240 described later is improved, so that cycle characteristics can be improved.

Examples of the inorganic substance contained as particles in the heat-resistant layer 232 include a metal, a semiconductor, oxides of a metal and a semiconductor, and nitrides of a metal and a semiconductor. Examples of the metal to be used as the inorganic substance include aluminum (Al) and titanium (Ti). Examples of the semiconductor to be used as the inorganic substance include silicon (Si) and boron (B). Examples of the oxides and the nitrides to be used as the inorganic substance include alumina (Al₂O₃), boron nitride (BN), aluminum nitride (AlN), titanium dioxide (TiO), and silicon dioxide (SiO). In addition, the inorganic substance preferably is one having insulating properties, being superior in availability, and having a large heat capacity.

The binder contained in the heat-resistant layer 232 may be an arbitrary material, and contains, for example, one or more of synthetic rubber and a polymer compound. Examples of the synthetic rubber include styrene-butadiene-based rubber, fluorine-based rubber, and ethylene propylene diene. Examples of the polymer compound includes polyvinylidene fluoride (PVdF) and polyimide.

The adhesive layer 240 is provided on at least one side of the positive electrode 210 side and the negative electrode 220 side of the separator 230, and bonds the separator 230 to the positive electrode 210 or the negative electrode 220 to inhibit peeling. In the example of FIG. 2, the adhesive layer 240 is provided on the outer surface of the heat-resistant layer 232, namely, the surface opposite from the substrate 231. This facilitates lamination of the separator 230 and the positive electrode 210 or the negative electrode 220. In addition, the distance between the positive electrode 210 and the negative electrode 220 can thereby be maintained at an appropriate distance. In addition, also when an abnormality occurs in the secondary battery 1 and a gas is generated, it is possible to inhibit the battery device 20 from being deformed by the gas to ignite.

In an embodiment, the adhesive layer 240 is provided to be scattered on the separator 230. Details of the area and shape of the region where the adhesive layer 240 is provided will be described later.

The adhesive layer 240 is provided on the separator 230, the positive electrode 210, or the negative electrode 220 by such a method as spraying with a spray, an inkjet method, or gravure printing. The adhesive layer 240 is preferably provided by an inkjet method or gravure printing. Thereby, the shape of dots of the adhesive layer 240 described later can be suitably adjusted. The adhesive layer 240 is preferably provided on the separator 230. Owing to this, the adhesive agent of the adhesive layer 240 penetrates into the pores of the positive electrode active material layer 212 or the negative electrode active material layer 222, so that the pores are clogged and, as a result, it is possible to inhibit an increase in resistance of the secondary battery 1.

The adhesive layer 240 contains a water-soluble binder. Examples of the binder contained in the adhesive layer 240 include polyacrylic acid. As a result, the separator 230 can be favorably bonded to the positive electrode 210 or the negative electrode 220 while reducing the environmental load related to the manufacture of the secondary battery 1 and inhibiting the manufacturing cost of the secondary battery 1.

The separator 230 is impregnated with the electrolytic solution. In the example of FIG. 1, the electrolytic solution is filled into a space in the outer package member 30. The electrolytic solution is a non-aqueous electrolytic solution containing an electrolyte salt and a non-aqueous solvent for dissolving the electrolyte salt.

Examples of the electrolyte salt include lithium salts such as lithium perchlorate (LiClO₄), lithium hexafluorophosphate (LiPF₆), lithium tetrafluoroborate (LiBF₄), lithium bis(trifluoromethanesulfonyl)imide (LiN(SO₂CF₃)₂), lithium bis(pentafluoroethanesulfonyl)imide (LiN(SO₂C₂F₅)₂), and lithium hexafluoroarsenate (LiAsF₆).

Examples of the solvent include non-aqueous solvents including lactone-based solvents such as γ-butyrolactone, γ-valerolactone, δ-valerolactone, and ε-caprolactone, carbonate-based solvents such as ethylene carbonate, propylene carbonate, butylene carbonate, vinylene carbonate, dimethyl carbonate, ethyl methyl carbonate, and diethyl carbonate, ether-based solvents such as 1,2-dimethoxyethane, 1-ethoxy-2-methoxyethane, 1,2-diethoxyethane, tetrahydrofuran, and 2-methyltetrahydrofuran, nitrile-based solvents such as acetonitrile, sulfolane-based solvents, phosphoric acids, phosphoric acid ester solvents, and pyrrolidones.

The electrolytic solution may further contain an additive such as a fluorinated carboxylic acid ester, a sulfonic acid ester, a sulfonic acid anhydride, or a carboxylic acid anhydride as an additive.

In the following, the region where the adhesive layer 240 is provided will be described in detail with reference to FIG. 3.

In the secondary battery 1 according to an embodiment, the positive electrode terminal and the negative electrode terminal are on the same side in the Y direction, which is a direction orthogonal to the Z direction, with respect to the geometric center C of the electrode body region E. In other words, there is a direction which is orthogonal to the Z direction and in which the positive electrode terminal and the negative electrode terminal are on the same side with respect to the geometric center C of the electrode body region E. Here, the first boundary T1 and the second boundary T2 are boundaries located on the same side in the Y direction of the electrode body region E, and are boundaries overlapping the ends in the Y direction of the electrode body region E.

In this case, when the adhesive layer 240 is uniformly provided in the electrode body region E, a charge-discharge reaction is promoted in a region on the side where the positive electrode terminal and the negative electrode terminal are present with respect to the geometric center C of the electrode body region E because the conduction path is short, and a charge-discharge reaction is inhibited in a region on the side opposite from the positive electrode terminal and the negative electrode terminal with respect to the geometric center C of the electrode body region E because the conduction path is long. In this case, the charge-discharge reaction is locally concentrated, so that the cycle characteristics may deteriorate.

In the following description, the first measurement region M1 and the second measurement region M2, which are two regions to be measured for the area ratio in which the adhesive layer 240 is provided, will be described.

The first measurement region M1 overlaps the shortest path in the electrode body region E from the first boundary T1 to the second boundary T2 in plan view in the Z direction. The shortest path in the electrode body region E from the first boundary T1 to the second boundary T2 is a path connecting the first boundary T1 to the second boundary T2, and indicates a path having the shortest length in plan view in the Z direction among paths the entire of each of which exists in the electrode body region E. In the example of FIG. 3, the shortest path in the electrode body region E from the first boundary T1 to the second boundary T2 is a path P, which extends along a side at an end in the Y direction overlapping the first boundary T1 and the second boundary T2 of the electrode body region E. Therefore, the first measurement region M1 is located between the first boundary T1 and the second boundary T2 in the X direction, and is located at an end in the Y direction overlapping the first boundary T1 and the second boundary T2 of the electrode body region E in the Y direction. The shape of the first measurement region M1 is a square, but is not limited thereto, and may be another shape such as a circular shape.

The second measurement region M2 is a region which is point-symmetric to the first measurement region M1 about the geometric center C of the electrode body region E in plan view in the Z direction and has the same area as the first measurement region M1. In other words, the geometric center M1a of the first measurement region M1 and the geometric center M2a of the second measurement region M2 are in a point-symmetric relationship about the geometric center C of the electrode body region E. In the example of FIG. 3, the second measurement region M2 is located between the first boundary T1 and the second boundary T2 in the X direction, and is located at the end in the Y direction opposite from the end in the Y direction overlapping the first boundary T1 and the second boundary T2 of the electrode body region E in the Y direction.

In the following description, the proportion of the area of the adhesive layer 240 occupying in the first measurement region M1 is denoted by A, and the proportion of the area of the adhesive layer 240 occupying in the second measurement region M2 is denoted by B. In this case, the ratio (A/B) of A to B is 1.1 or more and 1.5 or less.

Within this range, a charge-discharge reaction in the battery device 20 can be inhibited from locally occurring. This makes it possible to inhibit precipitation of metallic lithium at the time of charging due to local concentration of the charge-discharge reaction, so that it is possible to inhibit deterioration of cycle characteristics. When A/B is less than 1.1, the resistance in the conductive path passing through the first measurement region M1 is relatively small, and the charge-discharge reaction is concentrated, so that metallic lithium may precipitate during charging, and the cycle characteristics may deteriorate. When A/B is more than 1.5, the resistance in the conductive path passing through the second measurement region M2 is relatively small, and the charge-discharge reaction is concentrated, so that the current during charge and discharge is biased to the second measurement region M2, and the cycle characteristics may deteriorate. In addition, when A/B is set to less than 1.1 or more than 1.5, there is a deviation in the adhesive force of the adhesive layer depending on the location. Therefore, in a case where an abnormality occurs in the secondary battery 1 and a gas is generated, there is a possibility that the battery device 20 is deformed by the gas to ignite.

Here, A and B can be measured by observing the adhesive layer 240 with the first measurement region M1 and the second measurement region M2 as visual fields using an electron microscope such as a scanning electron microscope (SEM), and an optical microscope. More specifically, A and B can be calculated by disassembling the assembled battery, observing one of the separator 230 and the positive electrode 210 or the negative electrode 220 to which the adhesive layer 240 adheres in the first measurement region M1 and the second measurement region M2, specifying regions where the adhesive layer 240 exists on the basis of a difference in chromaticity, and calculating the proportion of the area of the regions occupying in the entire visual field.

The first measurement region M1 and the second measurement region M2 each are not specified to a single position of the electrode body region E, and the positions of the first measurement region M1 and the second measurement region M2 each may be a plurality of positions. In this case, the fact that A/B is 1.1 or more and 1.5 or less includes the fact that the proportion of the area of the adhesive layer 240 occupying in the region that can be determined as the second measurement region M2 to the proportion of the area of the adhesive layer 240 occupying in the region that can be determined as the first measurement region M1 is 1.1 or more and 1.5 or less for at least one set of regions among sets of regions that can be determined as the first measurement region M1 and the second measurement region M2.

In an embodiment, the fact that A/B is 1.1 or more and 1.5 or less includes the fact that in one principal face of at least one layer of one positive electrode 210, negative electrode 220, or separator 230, a ratio of the proportion of the area of the adhesive layer 240 occupying the second measurement region M2 to the proportion of the area of the adhesive layer 240 occupying the first measurement region M1 is 1.1 or more and 1.5 or less.

In the example of FIG. 3, a straight line L passing through the geometric center C of the electrode body region E and being parallel to the X direction is drawn to bisect the electrode body region E into a region E1 on a side where the first boundary T1 and the second boundary T2 exist with respect to the straight line L and a region E2 on a side where the first boundary T1 and the second boundary T2 do not exist with respect to the straight line L, and the proportion of the area of the adhesive layer 240 occupying in the two regions is made different in each region, whereby the value of A/B can be set to a desired value. The method of adjusting A/B is not limited to the method described above, and it is not necessary to vary the proportion of the area of the adhesive layer for each of the regions E1 and E2 obtained by dividing the electrode body region E as in the above method. For example, A/B may be adjusted by gradually varying the proportion of the area of the adhesive layer 240 in the Y direction from the side where the first boundary T1 and the second boundary T2 exist toward the side where the first boundary T1 and the second boundary T2 do not exist.

The proportion of the area of the adhesive layer 240 occupying in the electrode body region E in plan view in the Z direction (adhesive layer occupancy) is preferably 30% or more and 70% or less. Within this range, the adhesive force of the adhesive layer 240 can be made sufficient while inhibiting an increase in resistance by the adhesive layer 240. When the adhesive layer occupancy is less than 30%, there is a possibility that the adhesive force of the adhesive layer 240 is small. In addition, when the adhesive layer occupancy is more than 70%, the adhesive layer 240 serves as a resistance layer, and there is a possibility that the internal resistance of the secondary battery 1 increases.

Here, the adhesive layer occupancy can be measured by observing the adhesive layer 240 with an electron microscope such as an SEM, and an optical microscope. More specifically, the adhesive layer occupancy can be calculated by disassembling the assembled battery, observing one of the separator 230 and the positive electrode 210 or the negative electrode 220 to which the adhesive layer 240 adheres in the first measurement region M1 and the second measurement region M2, specifying regions where the adhesive layer 240 exists on the basis of a difference in chromaticity, measuring and summing the areas of the adhesive layer 240 in the respective measurement regions, and averaging the values obtained by dividing the sum by the area of the measurement region.

The fact that the adhesive layer occupancy is 30% or more and 70% or less includes the fact that the average of the proportion of the area of the adhesive layer 240 occupying in the region that can be determined as the first measurement region M1 and the proportion of the area of the adhesive layer 240 occupying in the region that can be determined as the second measurement region M2 is 30% or more and 70% or less for at least one set of regions among sets of regions that can be determined as the first measurement region M1 and the second measurement region M2.

In an embodiment, the fact that the adhesive layer occupancy is 30% or more and 70% or less includes the fact that in one principal face of at least one layer of one positive electrode 210, negative electrode 220, or separator 230, the average of the proportion of the area of the adhesive layer 240 occupying the first measurement region M1 and the proportion of the area of the adhesive layer 240 occupying the second measurement region M2 is 30% or more and 70% or less.

The adhesive force of the adhesive layer 240 is 0.38 N/mm or more. In this case, since the adhesiveness between the separator 230 and the positive electrode 210 or the negative electrode 220 is high, it is possible to inhibit the distance between the positive electrode and the negative electrode from increasing due to expansion and shrinkage of the positive electrode 210 and the negative electrode 220 in a charge-discharge cycle or an increase in internal pressure caused by gas generation at the time of occurrence of abnormality, and it is possible to improve cycle characteristics, maintain performance over a long period of time, inhibit ignition of the battery, and improve safety. Here, the adhesive force of the adhesive layer 240 can be measured with a tensile tester. More specifically, the peeling strength between the separator 230 and the positive electrode 210 or the negative electrode 220 measured with a tensile tester following disassembly of the assembled secondary battery 1 can be used as the adhesive force of the adhesive layer 240. When the peeling strength between the separator 230 and the positive electrode 210 is different from the peeling strength between the separator 230 and the negative electrode 220, the average of these peeling strengths can be used as the adhesive force of the adhesive layer 240.

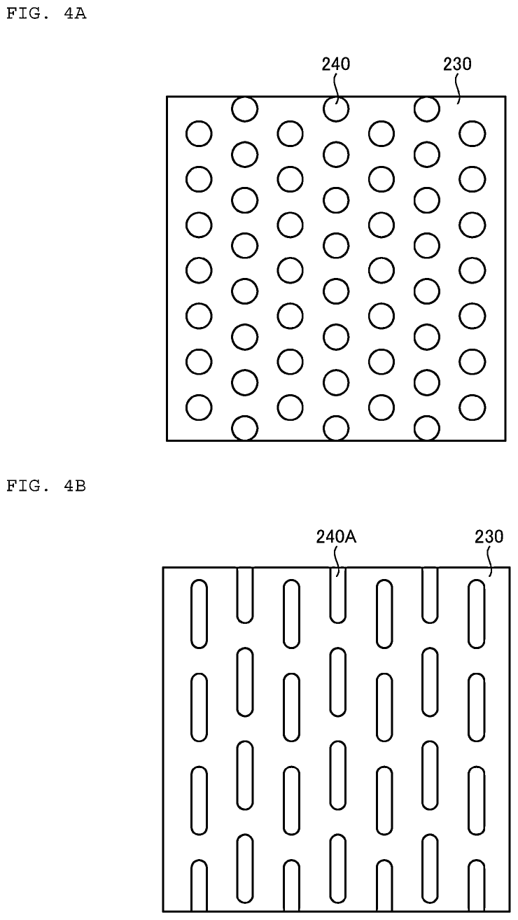

FIG. 4A is a schematic plan view illustrating one example of the separator and the adhesive layer according to FIG. 1. FIG. 4B is a schematic plan view illustrating a different example of the separator and the adhesive layer according to FIG. 1. As illustrated in FIGS. 4A and 4B, the shape of the adhesive layer 240 is a shape formed by a plurality of dots separated from each other. The shape of each dot is a circular shape as illustrated in FIG. 4A, but is not particularly limited. The shape of the dot may be a linear shape, namely, a figure extending in one direction, as illustrated in FIG. 4B, for example. The shape of the dot may be another shape. The plurality of dots are provided to be separated at regular intervals and have the same dot length direction as illustrated in FIGS. 4A and 4B, but this is merely an example, and the present disclosure is not limited thereto.

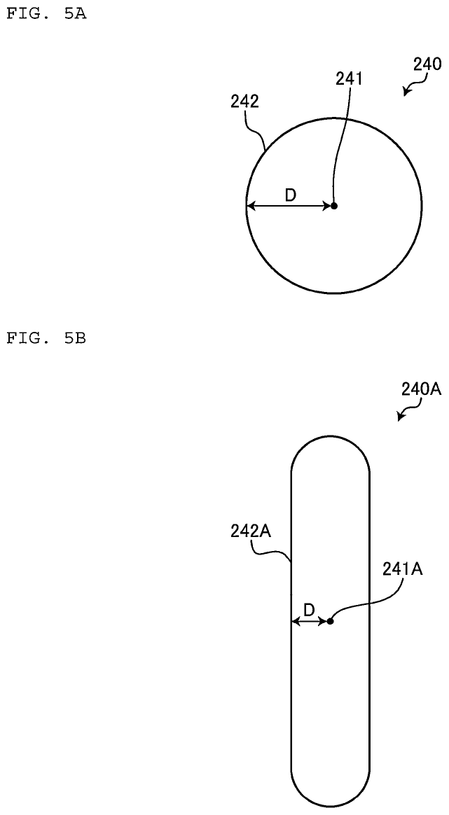

FIG. 5A is a plan view illustrating the shape of the dots of the adhesive layer according to FIG. 4A. FIG. 5B is a plan view illustrating the shape of the dots of the adhesive layer according to FIG. 4B. As illustrated in FIGS. 5A and 5B, the average shortest distance (dot size D) from the geometric center 241 of the dot to the contour 242 is preferably 20 μm or more and 1000 μm or less. This makes it possible to improve cycle characteristics while making the adhesive force of the adhesive layer 240 sufficient. On the other hand, when the dot size D is less than 20 μm, the adhesive force of the adhesive layer 240 may decrease. When the dot size D is larger than 1000 μm, the length of the conduction path of lithium ions per unit time increases, and thus lithium ions are unevenly distributed around the contour 242 of the dot during the charge-discharge reaction, so that the cycle characteristics may deteriorate.

Here, when the dot is circular as in FIG. 5A, the geometric center 241 of the dot indicates the center of the circle. When the dot is in a linear shape as illustrated in FIG. 5B, the geometric center 241A of the dot indicates a position that is the geometric center of the linear shape. The contours 242 and 242A each indicate an end of a region occupied by a dot, and are each a boundary between a region to which the adhesive layer 240 is applied and a region to which the adhesive layer 240 is not applied. Here, the region where the adhesive layer 240 is applied includes regions where the adhesive layer 240 has permeated the separator 230, the positive electrode 210, and the negative electrode 220. The average shortest distance from the geometric center 241 of the dot to the contour 242 refers to the average of the shortest distances from the geometric center 241 to the contour 242 measured for a plurality of dots.

The shortest distance from the geometric center 241 to the contour 242 can be measured by observing the adhesive layer 240 with an electron microscope such as an SEM, and an optical microscope. More specifically, the average shortest distance from the geometric center 241 of a dot to the contour 242 (dot size D) can be calculated by disassembling the assembled battery, observing one of the separator 230 and the positive electrode 210 or the negative electrode 220 to which the adhesive layer 240 adheres in a measurement region in the electrode body region E, specifying a region where the adhesive layer 240 exists on the basis of a difference in chromaticity, extracting the dots in a prescribed measurement region from the observed image of a microscope, measuring and summing the shortest distance from the geometric center 241 to the contour 242 for the dots in the measurement region, and dividing the sum by the number of the dots in the measurement region.

In the calculation of the dot size D, the position of the measurement region is not particularly limited as long as it is within the electrode body region E. That the dot size D is 20 μm or more and 1000 μm or less includes that in one principal face of at least one layer of one positive electrode 210, negative electrode 220, or separator 230, the dot size D in at least one measurement region is 20 μm or more and 1000 μm or less.

Although the battery according to an embodiment has been described above, the secondary battery according to an embodiment is not limited to that illustrated in FIG. 1. Hereinafter, other examples will be described with reference to drawings, but configurations similar to those in FIGS. 1 and 2 are denoted by reference numerals, and description thereof will be omitted.

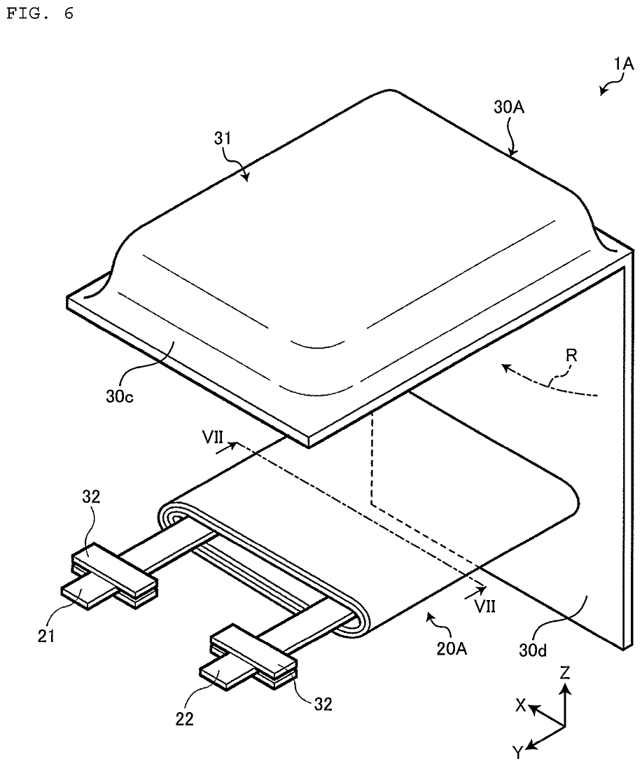

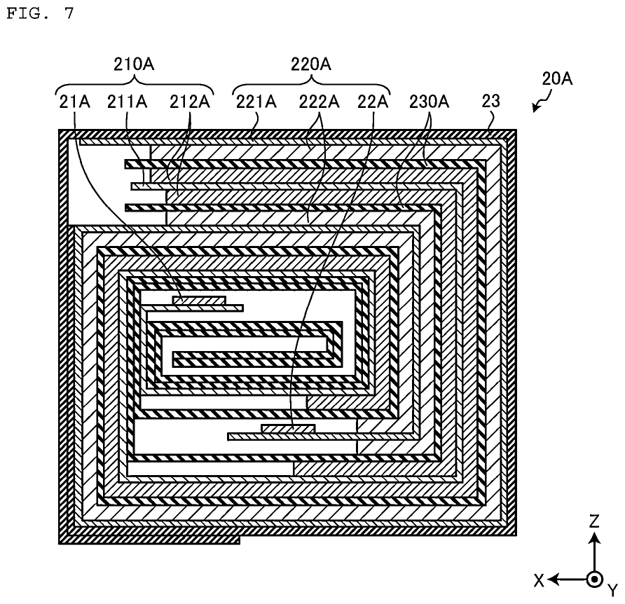

FIG. 6 is a development view illustrating a different example of the secondary battery according to an embodiment. FIG. 7 is a schematic sectional view taken along line VII-VII of FIG. 6. The secondary battery 1A illustrated in FIGS. 6 and 7 is different from the example according to FIG. 1 in that the secondary battery has a structure in which the battery device 20A is wound around the positive electrode lead 21A and the negative electrode lead 22A.

In the example of FIG. 6, the outer package member 30A is a sheet including an exterior sheet 30c provided with a recess 31 and an exterior sheet 30d that covers the recess 31 by being bent in the R direction. Thus, the battery device 20 is housed in the recess 31 of the exterior sheet 30c, the exterior sheet 30d is bent in the R direction, and the peripheral edges of the exterior sheet 30c and the exterior sheet 30d are bonded, whereby the battery device 20 is housed in the outer package member 30A.

The battery device 20A is provided inside the outer package member 30. As illustrated in FIG. 6, the battery device 20A according to an embodiment includes a positive electrode 210A, a negative electrode 220A, a separator 230, an adhesive layer (not shown), and a protective member 23.

The protective member 23 is a member that protects the exterior of the battery device 20A. The protective member 23 is provided to be wound around the outside of the battery device 20A. The protective member 23 is, for example, an insulator tape.

The battery device 20A has a structure in which the battery device 20A is wound around the positive electrode lead 21A and the negative electrode lead 22A, and the negative electrode current collector 221A, the negative electrode active material layer 222A, the separator 230A, the positive electrode active material layer 212A, the positive electrode current collector 211A, the positive electrode active material layer 212A, the separator 230A, and the negative electrode active material layer 222A are stacked in this order from the outside, namely, from the protective member 23 side. Here, adhesive layers are provided on both surfaces of the separator 230A, and the separator 230A is joined to the positive electrode 210A or the negative electrode 220A. In the battery device 20A, no layer other than the negative electrode current collector 221A, the separator 230A, and the positive electrode current collector 211A is provided in the vicinity of the positive electrode lead 21A and the negative electrode lead 22A. With this structure, the positive electrode current collector 211A is connected to the positive electrode lead 21A, and the negative electrode current collector 221A is connected to the negative electrode lead 22A.

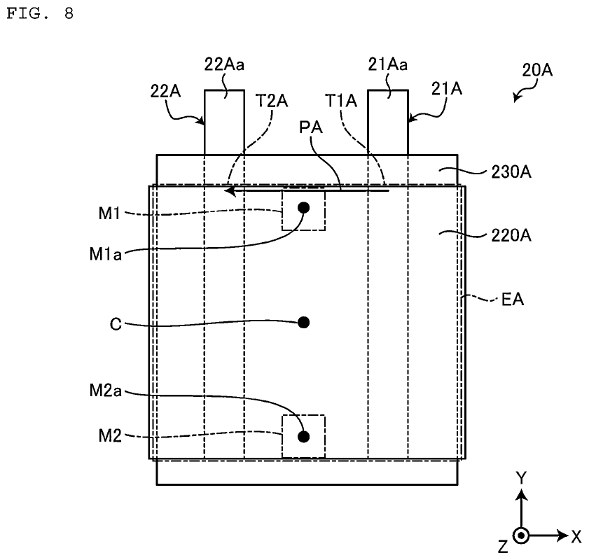

FIG. 8 is a schematic plan view of the battery device according to FIG. 6. More specifically, FIG. 8 is a plan view illustrating the battery device 20A from which the protective member 23 has been removed. In the example of FIGS. 7 and 8, the positive electrode 210A and the negative electrode 220A are sheet-like members and have no tab. The positive electrode lead 21A is provided near the center of the battery device 20A in plan view from the Y direction. The negative electrode lead 22A is provided near the center of the battery device 20A in plan view from the Y direction.

In the example of FIG. 8, a protruding part 21Aa, which is a portion protruding in the Y direction from the electrode body region EA of the positive electrode lead 21A, corresponds to a positive electrode terminal. A protruding part 22Aa, which is a portion protruding in the Y direction from the electrode body region EA of the negative electrode lead 22A, corresponds to a negative electrode terminal.

In the example of FIG. 8, the first boundary T1A indicates a part of the positive electrode 210 connected to the end of the protruding part 21Aa on the electrode body region EA side. The second boundary T2A indicates a part of the positive electrode 210 connected to the end of the protruding part 22Aa on the electrode body region EA side.

In the example of FIG. 8, the shortest path in the electrode body region EA from the positive electrode terminal to the negative electrode terminal is a path PA, which extends along a side at an end in the Y direction overlapping the first boundary T1 and the second boundary T2 of the electrode body region EA. Therefore, the first measurement region M1 is located between the first boundary TA and the second boundary T2A of the electrode body region EA in the X direction, and is located at an end in the Y direction overlapping the first boundary T1 and the second boundary T2 of the electrode body region EA in the Y direction. The second measurement region M2 is located between the first boundary TIA and the second boundary T2A in the X direction, and is located at the end in the Y direction opposite from the end in the Y direction overlapping the first boundary TIA and the second boundary T2A of the electrode body region EA in the Y direction.

In an embodiment, the fact that A/B is 1.1 or more and 1.5 or less includes the fact that in one principal face of at least one layer of the positive electrode 210A, negative electrode 220A, or separator 230A in a wound state, a ratio of the proportion of the area of the adhesive layer 240 occupying the second measurement region M2 to the proportion of the area of the adhesive layer 240 occupying the first measurement region M1 is 1.1 or more and 1.5 or less.

In an embodiment, the fact that A/B is 1.1 or more and 1.5 or less includes the fact that in one principal face of at least one layer of the positive electrode 210, negative electrode 220, or separator 230 in a wound state, the average of the proportion of the area of the adhesive layer 240 occupying the first measurement region M1 to the proportion of the area of the adhesive layer 240 occupying the second measurement region M2 is 30% or more and 70% or less.

As described above, the secondary battery according to an embodiment includes the positive electrode, the negative electrode, the separator stacked in the first direction between the principal face of the positive electrode and the principal face of the negative electrode, the adhesive layer provided on at least one of the principal faces of the separator on the positive electrode side and the negative electrode side, and the electrolytic solution. The adhesive layer contains a water-soluble binder. Regarding a region where the positive electrode, the negative electrode, and the separator are stacked and overlapped as an electrode body region, the positive electrode has a positive electrode terminal which is a portion protruding from the electrode body region in plan view in the first direction, and the negative electrode has a negative electrode terminal which is a portion protruding from the electrode body region in plan view in the first direction. The positive electrode terminal and the negative electrode terminal are located on the same side in a direction orthogonal to the first direction with respect to the geometric center of the electrode body region. When, in plan view in the first direction, a region overlapping a shortest path in the electrode body region from a first boundary where the positive electrode terminal is connected to the electrode body region to a second boundary where the negative electrode terminal is connected to the electrode body region is defined as a first measurement region, and a region that is point-symmetric to the first measurement region about a geometric center of the electrode body region and has an area equal to that of the first measurement region is defined as a second measurement region, and where an area proportion occupied by the adhesive layer in the first measurement region is denoted by A and an area proportion occupied by the adhesive layer in the second measurement region is denoted by B, the ratio of A to B is 1.1 or more and 1.5 or less. This makes it possible to inhibit precipitation of metallic lithium at the time of charging due to local concentration of the charge-discharge reaction, so that it is possible to inhibit deterioration of cycle characteristics.

In an embodiment, the separator has a substrate and heat-resistant layers provided on both principal faces of the substrate. The heat-resistant layer contains a binder and particles made of an inorganic substance. Thereby, the heat resistance of the heat-resistant layer can be improved, so that the heat resistance of the secondary battery can be improved. In addition, owing to the fact that the heat-resistant layer contains the binder, the adhesiveness of the adhesive layer is improved, so that cycle characteristics can be improved.

In an embodiment, in plan view in the first direction, the proportion of the area of the adhesive layer occupying in the electrode body region is 30% or more and 70% or less. The adhesive force of the adhesive layer is 0.38 N/mm or more. Within this range, the adhesive force of the adhesive layer can be made sufficient while inhibiting an increase in resistance by the adhesive layer. In addition, it is possible to inhibit the distance between the positive electrode and the negative electrode from increasing due to expansion and shrinkage of the positive electrode and the negative electrode in a charge-discharge cycle or an increase in internal pressure caused by gas generation at the time of occurrence of abnormality, and it is possible to improve cycle characteristics, maintain performance over a long period of time, inhibit ignition of the battery, and improve safety.

In an embodiment, in plan view in the first direction, the shape of the adhesive layer is a shape formed by a plurality of dots separated from each other. The average of the shortest distances from the geometric center of the dot to the contour is 1000 μm or less. This makes it possible to improve cycle characteristics while making the adhesive force of the adhesive layer 240 sufficient.

### EXAMPLES

Hereinafter, examples will be described according to an embodiment. It is noted that the present disclosure is not limited to the following examples. In addition, unless otherwise specified, the tests and measurements of the batteries according to the examples are performed in an environment of normal temperature (5° C. or higher and 35° C. or lower).

Table 1 is a table showing Examples 1 to 3 and Comparative Examples 1 to 4. In Examples 1 to 3 and Comparative Examples 1 to 4, batteries were prepared by varying A/B, and the measurements were performed.

TABLE 1

| | | | | Direct | |
|---|---|---|---|---|---|
| | | Adhesive | | current | |
| | | layer | 500 Cycle | resistance | Result of |
| | | occupancy | retention | (relative | 130° C. |
| Examples | A/B | [%] | rate [%] | ratio) [%] | heating test |
| Example 1 | 1.1 | 50 | 77 | 103 | A |
| Example 2 | 1.3 | 50 | 76 | 102 | A |
| Example 3 | 1.5 | 50 | 72 | 105 | A |
| Comparative | 0.7 | 50 | 52 | 98 | B |
| Example 1 | | | | | |
| Comparative | 1.0 | 50 | 15 | 100 | A |
| Example 2 | | | | | |
| Comparative | 1.7 | 50 | 58 | 115 | A |
| Example 3 | | | | | |
| Comparative | 2.0 | 50 | 44 | 125 | B |
| Example 4 | | | | | |

### Example 1

The battery according to Example 1 was manufactured and measured by the methods described below.

A positive electrode according to Example 1 was prepared by applying a positive electrode slurry obtained by mixing 91 mass % of LiNi_{0.5}Co_{0.2}Mn_{0.3}O₂ as a positive electrode active material, 3 mass % of polyvinylidene fluoride as a binder, and 6 mass % of conductive aid graphite was applied to an aluminum foil as a positive electrode current collector layer, drying it, and thereby forming a positive electrode active material layer. The shape of the positive electrode according to Example 1 was a rectangular sheet with a tab provided on one side.

A negative electrode according to Example 1 was prepared by applying a negative electrode slurry obtained by mixing 92 mass % of artificial graphite as a negative electrode active material, 7 mass % of polyvinylidene fluoride as a binder, and 1 mass % of graphite as a conductive aid was applied to a copper foil as a negative electrode current collector layer, drying it, and thereby forming a negative electrode active material layer. The shape of the negative electrode according to Example 1 was a rectangular sheet with a tab provided on one side.

The separator according to Example 1 was a product prepared by applying a layer containing aluminum oxide as inorganic particles and a polyamide resin as a binder as a heat-resistant layer to both surfaces of a polypropylene sheet as a substrate. The shape of the separator according to Example 1 was a rectangular sheet.

In Example 1, an adhesive layer was applied to the separator by an inkjet method. More specifically, the adhesive layer was provided on the separator by dropping an aqueous polyacrylic acid solution on the separator such that the solution was dispersed in a dot shape, and then drying it. In Example 1, the dot shape was a circular shape with a dot size D of 100 μm. As illustrated in FIG. 4A, dots were arranged to be separated from each other at equal intervals, and were provided such that the adhesive layer occupancy was 50%.

The electrolytic solution according to Example 1 was prepared by dissolving lithium hexafluorophosphate as a solute to have a concentration of 15 mass % in a solvent obtained by mixing ethylene carbonate, ethyl methyl carbonate, and vinylene carbonate at a volume ratio of 30:69:1.

The battery according to Example 1 was manufactured by stacking the positive electrode, the separator, and the negative electrode in this order, and impregnating the separator with the electrolytic solution. Here, the positive electrode and the negative electrode were stacked such that the tab of the positive electrode and the tab of the negative electrode protruded from the same side with respect to the geometric center of the electrode body region.

Here, in the separator, a straight line passing through the geometric center of the electrode body region and parallel to a side where the positive electrode terminal and the negative electrode terminal were present, namely, a side where the positive electrode tab and the negative electrode tab were present was drawn, and the straight line was bisected into a region on a side where the positive electrode tab and the negative electrode tab were present with respect to the straight line and a region on a side where neither the positive electrode tab nor the negative electrode tab were present with respect to the straight line, and the adhesive layer 240 was provided such that the proportions of the area of the adhesive layer occupying in the two regions were different between the regions. Thus, a battery was produced such that the value of A/B was 1.1.

### <<Charge-Discharge Cycle Test>>

The battery manufactured was subjected to a charge-discharge cycle test. In the charge-discharge cycle, the manufactured battery was subjected to constant-current constant-voltage charge up to an upper limit voltage of 4.2 V and a lower limit current of 0.05 C at a current of 1 C, and then to constant-current discharge up to a lower limit voltage of 2.5 V at a current of 5 C, and paused for 5 minutes. In the charge-discharge cycle test, the discharge capacity of the battery after 500 cycles of the charge-discharge cycle was measured, and the 500 cycle retention rate was calculated as the ratio of the discharge capacity according to the following formula (1).

Cycle retention rate (%)=(discharge capacity after 500 cycles/discharge capacity after 1 cycle)×100 (1)

### <<Measurement of Direct Current Resistance>>

The battery manufactured was subjected to direct current resistance measurement. In the direct current resistance measurement, the direct current resistance was measured by measuring the drop in voltage between the positive electrode tab and the negative electrode tab with respect to the direct current. The direct current resistance measured was calculated as a relative value with respect to the value in Comparative Example 2 described later.

### <<Heating Test>>

The battery manufactured was subjected to a heating test. In the heating test, the manufactured battery in a fully charged state was placed in a thermostatic chamber, the temperature in the thermostatic chamber was raised up to 130° C. at a temperature raising rate of 5° C./min, and the temperature in the thermostatic chamber was allowed to stand at 130° C. for 60 minutes. When the battery did not ignite during the measurement, the result was regarded as A. On the other hand, when the battery ignited during the measurement, the result was regarded as B.

### Example 2

In Example 2, a battery was manufactured in the same manner as in Example 1 except that A/B was 1.3 as indicated in Table 1, and the measurements were performed.

### Example 3

In Example 3, a battery was manufactured in the same manner as in Example 1 except that A/B was 1.5 as indicated in Table 1, and the measurements were performed.

### Comparative Example 1

In Comparative Example 1, a battery was manufactured in the same manner as in Example 1 except that A/B was 0.7 as indicated in Table 1, and the measurements were performed.

### Comparative Example 2

In Comparative Example 2, a battery was manufactured in the same manner as in Example 1 except that A/B was 1.0 as indicated in Table 1, and the measurements were performed.

### Comparative Example 3

In Comparative Example 3, a battery was manufactured in the same manner as in Example 1 except that A/B was 1.7 as indicated in Table 1, and the measurements were performed.

### Comparative Example 4

In Comparative Example 4, a battery was manufactured in the same manner as in Example 1 except that A/B was 2.0 as indicated in Table 1, and the measurements were performed.

As indicated in Table 1, in Examples 1 to 4, by setting A/B to 1.1 or more and 1.5 or less, the cycle retention rate could be improved as compared with Comparative Examples 1 to 4, in which A/B was less than 1.1 or A/B was more than 1.5.

As indicated in Table 1, in Examples 1 to 4, by setting A/B to 1.0 or more and 1.7 or less, ignition in a high-temperature environment could be inhibited as compared with Comparative Example 1, in which A/B was less than 1.0, and Comparative Example 4, in which A/B was more than 1.5. Here, it is considered that the batteries ignited in Comparative Examples 1 and 4 because gas was generated in the batteries in a high-temperature environment, so that a short circuit occurred in the batteries.

Table 2 is a table indicating Examples 4 to 8 and Comparative Example 5. In Examples 4 to 8 and Comparative Example 5, batteries were manufactured by varying the adhesive layer occupancy and the adhesive force, and measurements were performed.

TABLE 2

| | | | Adhesive | | Direct | |
|---|---|---|---|---|---|---|
| | | Adhesive | force of | | current | Result of |
| | | layer | adhesive | 500 Cycle | resistance | 130° C. |
| | | occupancy | layer | retention | (relative | heating |
| Examples | A/B | [%] | [N/mm] | rate [%] | ratio) [%] | test |
| Example 4 | 1.1 | 30 | 0.38 | 75 | 98 | A |
| Example 5 | 1.1 | 50 | 0.55 | 77 | 103 | A |
| Example 6 | 1.1 | 70 | 0.61 | 72 | 106 | A |
| Comparative | — | 0 | 0 | 27 | 92 | B |
| Example 5 | | | | | | |
| Example 7 | 1.1 | 10 | 0.17 | 56 | 96 | B |
| Example 8 | 1.1 | 80 | 0.72 | 46 | 118 | A |

In Example 4, a battery was manufactured in the same manner as in Example 1 except that the adhesive layer occupancy was set to 30%.

### <<Adhesive Force Measurement>>

In Example 4, the adhesive force of the battery manufactured was measured. In the adhesive force measurement, the separator and the positive electrode were pulled, the stress (peeling stress) applied until peeling occurred was measured, and the measured peeling stress was taken as the adhesive force. In Example 4, the adhesive force of the adhesive layer was 0.38 N/mm.

In Example 4, a charge-discharge cycle test, direct current resistance measurement, and a heating test were performed in the same manner as in Example 1.

### Example 5

In Example 5, a battery was manufactured in the same manner as in Example 4 except that the adhesive layer occupancy was set to 50% as indicated in Table 2, and the measurements were performed. In Example 5, the adhesive force of the adhesive layer was 0.55 N/mm.

### Example 6

In Example 6, a battery was manufactured in the same manner as in Example 4 except that the adhesive layer occupancy was set to 70% as indicated in Table 2, and the measurements were performed. In Example 6, the adhesive force of the adhesive layer was 0.61 N/mm.

### Comparative Example 5

In Comparative Example 5, a battery was manufactured in the same manner as in Example 4 except that the adhesive layer occupancy was set to 0% as indicated in Table 2, in other words, no adhesive layer was formed, and the measurements were performed. In Comparative Example 5, the adhesive force of the adhesive layer was 0 N/mm. That is, the separator and the positive electrode or the negative electrode were not adhered to each other.

### Example 7

In Example 7, a battery was manufactured in the same manner as in Example 4 except that the adhesive layer occupancy was set to 10% as indicated in Table 2, and the measurements were performed. In Example 7, the adhesive force of the adhesive layer was 0.17 N/mm.

### Example 8

In Example 8, a battery was manufactured in the same manner as in Example 4 except that the adhesive layer occupancy was set to 80% as indicated in Table 2, and the measurements were performed. In Example 8, the adhesive force of the adhesive layer was 0.72 N/mm.

As indicated in Table 2, in Examples 4 to 6, by setting the adhesive layer occupancy to 30% or more, the adhesive force of the adhesive layer could be set to 0.38 N/mm or more and ignition in a high-temperature environment could be inhibited as compared with Comparative Example 5 and Example 7, in which the adhesive layer occupancy was less than 30%. Here, it is considered that the batteries ignited in Comparative Examples 5 and 6 because gas was generated in the batteries in a high-temperature environment, so that a short circuit occurred in the batteries.

As indicated in Table 2, in Examples 4 to 6, by setting the adhesive layer occupancy to 70% or less, the direct current resistance could be suppressed as compared with Example 8, in which the adhesive layer occupancy was more than 70%.

Table 3 is a table indicating Examples 9 to 20. In Examples 9 to 20, batteries were manufactured by varying the dot shape and the dot size D, and the measurements were performed.

TABLE 3

| | | | | | Adhesive | | Direct |
|---|---|---|---|---|---|---|---|
| | | Adhesive | | | force of | | current |
| | | layer | | | adhesive | 500 Cycle | resistance |
| | | occupancy | Dot | Dot size | layer | retention | (relative |
| Examples | A/B | [%] | shape | D [μm] | [N/mm] | rate [%] | ratio) [%] |
| Example | 1.1 | 50 | Circular | 20 | 0.42 | 72 | 99 |
| 9 | | | | | | | |
| Example | 1.1 | 50 | Circular | 100 | 0.55 | 77 | 103 |
| 10 | | | | | | | |
| Example | 1.1 | 50 | Circular | 500 | 0.54 | 74 | 104 |
| 11 | | | | | | | |
| Example | 1.1 | 50 | Circular | 1000 | 0.59 | 76 | 106 |
| 12 | | | | | | | |
| Example | 1.1 | 50 | Linear | 20 | 0.49 | 77 | 100 |
| 13 | | | | | | | |
| Example | 1.1 | 50 | Linear | 100 | 0.59 | 75 | 102 |
| 14 | | | | | | | |
| Example | 1.1 | 50 | Linear | 500 | 0.58 | 79 | 102 |
| 15 | | | | | | | |
| Example | 1.1 | 50 | Linear | 1000 | 0.64 | 74 | 108 |
| 16 | | | | | | | |
| Example | 1.1 | 50 | Circular | 10 | 0.11 | 41 | 99 |
| 17 | | | | | | | |
| Example | 1.1 | 50 | Linear | 10 | 0.27 | 43 | 101 |
| 18 | | | | | | | |
| Example | 1.1 | 50 | Circular | 1500 | 0.69 | 63 | 118 |
| 19 | | | | | | | |
| Example | 1.1 | 50 | Linear | 1500 | 0.71 | 59 | 125 |
| 20 | | | | | | | |

### Example 9

In Example 9, a battery was manufactured in the same manner as in Example 1 except that the shape of the adhesive layer was circular and the dot size D was set to 20 μm.

In Example 9, adhesive force measurement, a charge-discharge cycle test, and direct current resistance measurement were performed in the same manner as in Example 4. In Example 9, the adhesive force of the adhesive layer was 0.42 N/mm.

### Example 10

In Example 10, a battery was manufactured in the same manner as in Example 9 except that the dot size D was set to 100 μm as indicated in Table 3, and the measurements were performed. In Example 10, the adhesive force of the adhesive layer was 0.55 N/mm.

### Example 11

In Example 11, a battery was manufactured in the same manner as in Example 9 except that the dot size D was set to 500 μm as indicated in Table 3, and the measurements were performed. In Example 11, the adhesive force of the adhesive layer was 0.54 N/mm.

### Example 12

In Example 12, a battery was manufactured in the same manner as in Example 9 except that the dot size D was set to 1000 μm as indicated in Table 3, and the measurements were performed. In Example 12, the adhesive force of the adhesive layer was 0.59 N/mm.

### Example 13

In Example 13, a battery was manufactured in the same manner as in Example 9 except that the dot shape was linear and the dot size D was set to 20 μm as indicated in Table 3, and the measurements were performed. In Example 13, the adhesive force of the adhesive layer was 0.49 N/mm.

### Example 14

In Example 14, a battery was manufactured in the same manner as in Example 9 except that the dot shape was linear and the dot size D was set to 100 μm as indicated in Table 3, and the measurements were performed. In Example 14, the adhesive force of the adhesive layer was 0.59 N/mm.

### Example 15

In Example 15, a battery was manufactured in the same manner as in Example 9 except that the dot shape was linear and the dot size D was set to 500 μm as indicated in Table 3, and the measurements were performed. In Example 15, the adhesive force of the adhesive layer was 0.58 N/mm.

### Example 16

In Example 16, a battery was manufactured in the same manner as in Example 9 except that the dot shape was linear and the dot size D was set to 1000 μm as indicated in Table 3, and the measurements were performed. In Example 16, the adhesive force of the adhesive layer was 0.64 N/mm.

### Example 17

In Example 17, a battery was manufactured in the same manner as in Example 9 except that the dot size D was set to 10 μm as indicated in Table 3, and the measurements were performed. In Example 17, the adhesive force of the adhesive layer was 0.11 N/mm.

### Example 18

In Example 18, a battery was manufactured in the same manner as in Example 9 except that the dot shape was linear and the dot size D was set to 10 μm as indicated in Table 3, and the measurements were performed. In Example 18, the adhesive force of the adhesive layer was 0.11 N/mm.

### Example 19

In Example 19, a battery was manufactured in the same manner as in Example 9 except that the dot size D was set to 1500 μm as indicated in Table 3, and the measurements were performed. In Example 19, the adhesive force of the adhesive layer was 0.69 N/mm.

### Example 20

In Example 20, a battery was manufactured in the same manner as in Example 9 except that the dot size D was set to 1500 μm as indicated in Table 3, and the measurements were performed. In Example 20, the adhesive force of the adhesive layer was 0.71 N/mm.

As indicated in Table 3, in Examples 9 to 14, by setting the dot size D to 1000 μm or less, the cycle characteristics could be improved as compared with Examples 19 and 20, in which the dot size D was larger than 1000 μm.

As indicated in Table 3, in Examples 9 to 14, by setting the dot size D to 20 μm or more, the adhesive force of the adhesive layer could be set to 0.38 N/mm or more and the adhesive force could be improved as compared with Examples 17 and 18, in which the dot size D was less than 20 μm.

It is noted that the present disclosure also relates to the following embodiments.

(1)

A secondary battery including:
a positive electrode;
a negative electrode;
a separator stacked in a first direction between a principal face of the positive electrode and a principal face of the negative electrode;
an adhesive layer provided on a principal face of the separator on at least one of a positive electrode side and a negative electrode side; and
an electrolytic solution,
in which
the adhesive layer contains a water-soluble binder;
a region where the positive electrode, the negative electrode, and the separator are stacked and overlapped is defined as an electrode body region;
the positive electrode includes a positive electrode terminal that is a portion protruding from the electrode body region in plan view in the first direction;
the negative electrode includes a negative electrode terminal that is a portion protruding from the electrode body region in plan view in the first direction;
the positive electrode terminal and the negative electrode terminal are located on the same side with respect to a geometric center of the electrode body region in a direction orthogonal to the first direction; and
when, in plan view in the first direction, a region overlapping a shortest path in the electrode body region from a first boundary where the positive electrode terminal is connected to the electrode body region to a second boundary where the negative electrode terminal is connected to the electrode body region is defined as a first measurement region, and a region that is point-symmetric to the first measurement region about a geometric center of the electrode body region and has an area equal to that of the first measurement region is defined as a second measurement region, and where an area proportion occupied by the adhesive layer in the first measurement region is denoted by A and an area proportion occupied by the adhesive layer in the second measurement region is denoted by B, a ratio of A to B is 1.1 or more and 1.5 or less.
   (2)

The secondary battery according to (1), in which the separator includes a substrate and heat-resistant layers on both principal faces of the substrate, and
the heat-resistant layers each contain a binder and particles made of an inorganic substance.
   (3)

The secondary battery according to (1) or (2), in which an area proportion occupied by the adhesive layer in the electrode body region in plan view in the first direction is 30% or more and 70% or less, and
the adhesive layer has an adhesive force of 0.38 N/mm or more.
   (4)

The secondary battery according to any one of (1) to (3), in which, in plan view in the first direction, a shape of the adhesive layer is a shape formed of a plurality of dots separated from each other, and
an average of shortest distances from a geometric center to a contour of the dots is 20 μm or more and 1000 μm or less.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode;
a separator stacked in a first direction between a principal face of the positive electrode and a principal face of the negative electrode;
an adhesive layer provided on a principal face of the separator on at least one of a positive electrode side and a negative electrode side; and
an electrolytic solution,
wherein
the adhesive layer contains a water-soluble binder;
a region where the positive electrode, the negative electrode, and the separator are stacked and overlapped is defined as an electrode body region;
the positive electrode includes a positive electrode terminal that is a portion protruding from the electrode body region in plan view in the first direction;
the negative electrode includes a negative electrode terminal that is a portion protruding from the electrode body region in plan view in the first direction;
the positive electrode terminal and the negative electrode terminal are located on the same side with respect to a geometric center of the electrode body region in a direction orthogonal to the first direction; and
when, in plan view in the first direction, a region overlapping a shortest path in the electrode body region from a first boundary where the positive electrode terminal is connected to the electrode body region to a second boundary where the negative electrode terminal is connected to the electrode body region is defined as a first measurement region, and a region that is point-symmetric to the first measurement region about a geometric center of the electrode body region and has an area equal to that of the first measurement region is defined as a second measurement region, and where an area proportion occupied by the adhesive layer in the first measurement region is denoted by A and an area proportion occupied by the adhesive layer in the second measurement region is denoted by B, a ratio of A to B is 1.1 or more and 1.5 or less.

2. The secondary battery according to claim 1, wherein the separator comprises a substrate and heat-resistant layers on both principal faces of the substrate, and
the heat-resistant layers each contain a binder and particles made of an inorganic substance.

3. The secondary battery according to claim 1, wherein an area proportion occupied by the adhesive layer in the electrode body region in plan view in the first direction is 30% or more and 70% or less, and
the adhesive layer has an adhesive force of 0.38 N/mm or more.

4. The secondary battery according to claim 1, wherein, in plan view in the first direction, a shape of the adhesive layer is a shape formed of a plurality of dots separated from each other, and
an average of shortest distances from a geometric center to a contour of the dots is 20 μm or more and 1000 μm or less.
